(19) United States
(12) Patent Application Publication
(10) Pub. No.: US 2014/0260790 A1
(43) Pub. Date: Sep. 18, 2014

(54) Ring Gear Shroud

(71) Applicant: Dana Heavy Vehicle Systems Group, LLC, Maumee, OH (US)

(72) Inventors: Benjamin J. Passino, Maumee, OH (US); David A. Harkleroad, Willis, MI (US); Scott L. Steward, JR., Malinta, OH (US); Michael R. Fetcho, Holland, OH (US); Peter A. Beesley, Fort Wayne, IN (US); Randy L. Sommer, Monvoeville, IN (US)

(21) Appl. No.: 14/199,241

(22) Filed: Mar. 6, 2014

Related U.S. Application Data
(60) Provisional application No. 61/787,042, filed on Mar. 15, 2013.

(51) Int. Cl. F16H 57/02

(52) U.S. Cl. CPC F16H 57/02
USPC 74/606 R

(57) ABSTRACT

A unitary and integrally formed ring gear shroud having a first end portion, an arc-shaped middle portion, a second end portion, a first side and a second side. The first end portion extends orthogonally from the arc-shaped middle portion. The second end portion extends orthogonally from the arc-shaped middle portion, opposite the first end portion. The first end portion and the second end portions each extend from the arc-shaped middle portion. The first and second sides each have an inner surface and an outer surface. The inner and outer surfaces of the first side define a first radiused opening. The inner and outer surfaces of the second side also define a second radiused opening, wherein the first opening has a larger radius than the second opening. The outer surfaces of the first side and the second side are non-symmetrical.

### RELATED APPLICATIONS

This application claims the benefit of U.S. Provisional Application No. 61/787,042 filed on Mar. 15, 2013. This application is a non-provisional application filed off of U.S. patent application Ser. No. 61/787,042 filed on Mar. 15, 2013, which is incorporated by reference in its entirety herein. This non-provisional application is being filed during the pendency of U.S. patent application Ser. No. 61/787,042.

### FIELD OF THE INVENTION

A ring gear shroud for use in a differential assembly.

### BACKGROUND OF THE INVENTION

Drive train systems are widely used for generating power from a source and for transferring such power from the source to a driven mechanism. Frequently, the source generates rotational power, and such rotational power is transferred from the source to a rotatably driven mechanism. For example, in most land vehicles in use today, an engine/transmission assembly generates rotational power, and such rotational power is transferred from an output shaft of the engine/transmission assembly through a hollow cylindrical driveshaft tube to an input shaft of an axle assembly so as to rotatably drive the wheels of the vehicle.

A typical differential assembly includes a number of rotatable components that transmit rotational power from the input shaft to the wheels. These rotatable components are usually enclosed in a protective non-rotatable housing. The housing typically includes a central carrier or differential (which rotatably supports a differential assembly therein) having a pair of outwardly extending tubes (which enclose the axle shafts extending from the differential assembly to the wheels of the vehicle). In a manner that is well known in the art, rotation of the differential assembly by the input shaft causes corresponding rotation of the output axle shafts.

The differential assembly employs gears that are driven by the input drive shaft. Typically, a drive ring gear, which comprises the matched set of a ring gear and pinion shaft gear, is attached to a differential assembly. The ring gear is driven by the pinion shaft gear, which is connected to the input drive shaft. The ring gear mechanically passes the input torque and rotation from the pinion shaft gear through side gears onto the wheels.

In many types of gear devices, such as in the differential assembly, it is necessary to provide some sort of lubricant fluid to lubricate the gear mesh. The lubricant fluid minimizes the generation of wear particles, and dissipates frictional heat generated in the gear mesh. In many such gear devices, the housing which surrounds the gears acts both as a reservoir for lubricant fluid, and as a heat transfer surface. It has been common practice to put enough lubricant within the housing so that each gear rotating about a shaft will be rotated through the fluid lubricant, and pick up some of the lubricant on the teeth of the gear, where some of it remains until those particular teeth come into meshing engagement with the teeth of a mating gear.

Although providing sufficient lubricant in the reservoir, such that the teeth of each gear along the shaft will pass just below the fill level of the lubricant, has proven to be generally satisfactory, in terms of the ability to lubricate, however there are certain disadvantages to the arrangement described. The use of this typical lubrication method requires that the lubricant level in the differential assembly be high enough for the teeth of the smallest diameter gear to pass through the lubricant, as the gear rotates.

The disadvantage of such an arrangement is that the largest gears, and perhaps the largest two or three gears, rotate through lubricant which is much deeper than is truly needed, merely to lubricate the teeth of those particular gears. In fact, it has been determined that the teeth of those larger gears rotating through a fairly deep reservoir of lubricant fluid, can result in substantial “churning losses”, thereby reducing efficiency to the drivetrain. These types of parasitic losses are the result of the resistance offered, by the lubricant, to the rotation of the gears.

Consequently, it would be beneficial to provide an envelope to reduce the oil around the ring gear so that the ring gear does not spin through excessive oil sump.

### SUMMARY OF THE INVENTION

A unitary and integrally formed ring gear shroud having a first end portion, an arc-shaped middle portion, a second end portion, a first side and a second side. The first end portion extends orthogonally from the arc-shaped middle portion, and a distal end of the first end portion is oriented parallel to the arc-shaped middle portion. The second end portion extends orthogonally from the arc-shaped middle portion, opposite the first end portion. A distal end of the second end portion is oriented parallel to the arc-shaped middle portion. The first end portion and the second end portions each extend from the arc-shaped middle portion. The first and second sides each have an inner surface and an outer surface. The inner and outer surfaces of the first side define a first radiused opening. The inner and outer surfaces of the second side also define a second radiused opening, wherein the first opening has a larger radius than the second opening. The outer surfaces of the first side and the second side are non-symmetrical.

Various objects and advantages of this invention will become apparent to those skilled in the art from the following detailed description of the preferred embodiments, when read in light of the accompanying drawing.

### BRIEF DESCRIPTION OF THE DRAWING

The above, as well as other advantages of the present invention, will become readily apparent to those skilled in the art from the following detailed description when considered in the light of the accompanying drawings in which:

FIG. 1 is a perspective view of the present invention;

FIG. 2 is a side view of the present invention and a ring gear;

FIG. 3 is a is a perspective view of the present invention in a differential assembly;

FIG. 4 is a perspective view of another embodiment of the present invention;

FIG. 5 is a cross-sectional side view of the present invention; and

FIG. 6 is a perspective view of the present invention and axle housing cover.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined herein. Hence, specific dimensions, directions or other physical characteristics relating to the embodiments disclosed are not to be considered as limiting, unless expressly stated otherwise.

FIG. 1 illustrates a ring gear shroud 10. The ring gear shroud 10 is formed from a steel sheet metal; however, it is understood that the ring gear shroud may be formed from other metals, a composite material, a plastic, or any other rigid and heat resistant material. Preferably, the ring gear shroud 10 is formed from a sheet metal having a thickness of about 1.0 to about 1.5 millimeters; however, it is understood that other thicknesses may be used. The ring gear shroud 10 formed from a metal may be formed or partially formed using a stamping process, a forging process, or a rolling process. Further, it is understood that the ring gear shroud 10 may be formed using a series of iterative manufacturing processes or that the ring gear shroud 10 may be subjected to a secondary operation for forming perforations there through or for removing excess material from the ring gear shroud, for example.

The ring gear shroud 10, as shown in FIG. 1, is a unitary, integrally formed member having a first end portion 12, an arc-shaped middle portion 14, a second end portion 16, a first side 18 and a second side 20.

The first end portion 12 extends orthogonally from the arc-shaped middle portion 14; however, it is understood that the first end portion 12 may extend in any direction not coinciding with the ring gear 70 or that the ring gear shroud 10 may omit the first end portion 12. A distal end 22 of the first end portion 12 is oriented parallel to the arc-shaped middle portion 14. When a lubricant (not shown) is disposed in an axle housing (not shown), the first end portion 12 is positioned above a fluid level of the lubricant.

The second end portion 16 extends orthogonally from the arc-shaped middle portion 14; however, it is understood that the second end portion 16 may extend in any direction not coinciding with the ring gear 70 or that the ring gear shroud 10 may omit the second end portion 16. A distal end 24 of the second end portion 16 is oriented parallel to the arc-shaped middle portion 14. When a lubricant (not shown) is disposed in an axle housing (not shown), the second end portion 16 is positioned below the fluid level of the lubricant. The first end portion 12 and said second end portion 16 each extend from the arc-shaped middle portion 14.

The middle portion 14 is a central, arc-shaped portion of the ring gear shroud 10. As most clearly shown in FIG. 2, the middle portion 14 extends circumferentially approximately 180 degrees. However, it is understood that the middle portion 14 may extend in any manner about the ring gear 70 not coinciding with the ring gear 70 or that the ring gear shroud 10 may have a circumferential path of other amounts. When a lubricant is disposed in an axle housing, the middle portion 14 is partially disposed in the lubricant.

The first side 18 has an inner surface 26 and an outer surface 28. The second side 20 also has an inner surface 30 and an outer surface 32. The inner and outer surfaces 26, 28 of the first side 18 define a first radiused opening 34, and the inner and outer surfaces 30, 32 of the second side 20 define a second radiused opening 36. The first opening 34 has a larger radius than the second opening 36. The outer surfaces 28, 32 of said first side 18 and said second side 20 are non-symmetrical.

As shown in FIGS. 2 and 3, the ring gear 70 is at least partially disposed within the ring gear shroud 10. The ring gear shroud 10 is coupled to an axle housing cover 68, as shown in FIGS. 2 and 6, using a plurality of fasteners or at least one weld; however, it is understood that the ring gear shroud 10 may be coupled to the axle housing or any non-rotatable component disposed in the axle housing. The ring gear shroud 10 is coupled to the axle housing cover 68 using at least one weld; however, it is understood that the ring gear shroud 10 may be coupled to the axle housing cover 68 in any conventional manner, such as using at least one fastener to couple the ring gear shroud 10 to the axle housing cover 68.

As shown in FIG. 3 and particularly FIG. 5, the ring gear shroud 10 has a cross-sectional shape corresponding to a shape of a portion of the ring gear 70. The outer surfaces 28, 32 of the first side 18 and the second side 20 combined are defined by, in series, a first straight edge portion 46, a first curved portion 48, a second straight edge portion 50, a second curved portion 52, a third straight edge portion 54, a third curved portion 56 and a fourth straight edge portion 58.

As discussed and shown in FIG. 3, the cross-sectional shape of the ring gear shroud 10 is complimentary to the shape of a portion of the ring gear 70. The outer surfaces 28, 32 of the first side 18 and second side 20 are non-symmetrical and similar to the contour of the ring gear 70.

As shown in FIG. 5, the first straight edge portion 46 of the first side 18 is substantially parallel to a backface 72 of the ring gear 70. The first curved portion 48 of said first side 18 is adjacent to a heel 74 of the ring gear 70. The third straight edge portion 54, the third curved portion 56 and the four straight edge portion 58 of the second side 20 are each nonparallel and adjacent teeth 76 of the ring gear 70.

The cross-sectional shape of the ring gear shroud 10 facilitates rotation of a portion of the ring gear 70 and a portion of a differential housing therein, without either the ring gear 70 or the differential housing contacting the ring gear shroud 10.

As shown in FIG. 5, an end 60 of the first straight edge portion 46 comprises a first L-shaped lip 62 extending perpendicularly outward from the first straight edge portion 46. Additionally, an end 64 of the fourth straight edge portion 58 comprises a second L-shaped lip 66 extending perpendicularly outward from the fourth straight edge 58. The second L-shaped lip 66 is larger than the first L-shaped lip 62.

Also as can be seen from FIG. 5 and partially in FIG. 3, the first L-shaped lip 62 of the first side 18 is radially bounded by the backface 72 of the ring gear 70; and the second L-shaped lip 66 on the second side 20 is radially inward from a toe 78 of the ring gear 70.

It is understood that an interstitial space, or gap 80, between the ring gear shroud 10 and the ring gear 70 may be determined based on at least a manufacturing process used to form the ring gear shroud 10, a lubrication requirement of a plurality of gears disposed within a differential housing, and a shape of the axle housing. As shown in FIG. 5, the width of the gap 80 is greater between the inner surface 26 of the first side 18 and the ring gear 70, than between the inner surface 30 of the second side 20 and the ring gear 70.

FIG. 4 illustrates an alternative embodiment of the ring gear shroud 10 shown in FIG. 1. The ring gear shroud 100, as shown in FIG. 4 is a unitary, integrally formed member having a first end portion 120, an arc-shaped middle portion 140, a second end portion 160, a first side 180 and a second side 200.

The first end portion 120 extends orthogonally from the arc-shaped middle portion 140; however, it is understood that the first end portion 120 may extend in any direction not coinciding with the ring gear 70 or that the ring gear shroud 100 may omit the first end portion 120. A distal end 220 of the first end portion 120 is oriented parallel to the arc-shaped middle portion 140. When a lubricant (not shown) is disposed in an axle housing (not shown), the first end portion 120 is positioned above a fluid level of the lubricant.

The distal end 220 of the first end portion 140 comprises an opening 380 defined by said first side 180, said second side 200 and a connecting wall 400 extending between them. The opening 380 is provided to allow the ring gear shroud 100 to intersect with an axle housing (not shown), wherein a portion of the axle housing extends into the opening 380.

The second end portion 160 extends orthogonally from the arc-shaped middle portion 140; however, it is understood that the second end portion 160 may extend in any direction not coinciding with the ring gear 70 or that the ring gear shroud 100 may omit the second end portion 160. A distal end 240 of the second end portion 160 is oriented parallel to the arc-shaped middle portion 140. The distal end 240 of the second end portion 160 comprises an opening 420 defined by the first side 180, said second side 200 and a connecting wall 440 extending between them. The opening 420 is provided to allow the ring gear shroud 100 to intersect with an axle housing (not shown), wherein a portion of the axle housing extends into the opening 420. When a lubricant (not shown) is disposed in an axle housing (not shown), the second end portion 160 is positioned below the fluid level of the lubricant. The first end portion 120 and the second end portion 160 each extend from the arc-shaped middle portion 140.

The middle portion 140 is a central, arc-shaped portion of the ring gear shroud 100. The middle portion 140 extends circumferentially approximately 180 degrees. However, it is understood that the middle portion 140 may extend in any manner about the ring gear 70 not coinciding with the ring gear 70 or that the ring gear shroud 100 may have a circumferential path of other amounts. When a lubricant is disposed in an axle housing, the middle portion 140 is partially disposed in the lubricant.

The first side 180 has an inner surface 260 and an outer surface 280. The second side 200 also has an inner surface 300 and an outer surface 320. The inner and outer surfaces 260, 280 of the first side 180 define a first radiused opening 340, and the inner and outer surfaces 300, 320 of the second side 200 define a second radiused opening 360. The first opening 340 has a larger radius than the second opening 360. The outer surfaces 280, 320 of the first side 180 and the second side 200 are non-symmetrical.

As shown in FIG. 4, the ring gear shroud 100 has a cross-sectional shape corresponding to a shape of a portion of the ring gear 70. The cross-sectional shape of the ring gear shroud 100 is complimentary to the shape of a portion of the ring gear 70. The outer surfaces 280, 320 of the first side 180 and second side 200 are non-symmetrical and similar to the contour of the ring gear 70. A first straight edge portion 460 of the first side 180 is substantially parallel to a backface 72 of the ring gear 70. A first curved portion 480 of said first side 180 is adjacent to a heel 74 of the ring gear 70. A third straight edge portion 540, a third curved portion 560, and a four straight edge portion 580 of the second side 200 are each nonparallel and adjacent teeth 76 of the ring gear 70.

As shown in FIG. 4, the first straight edge portion 460 comprises a first L-shaped lip 620 extending perpendicularly outward from the first straight edge portion 460. Additionally, the fourth straight edge portion 580 comprises a second L-shaped lip 660 extending perpendicularly outward from the fourth straight edge 580. The second L-shaped lip 660 is larger than the first L-shaped lip 620.

The ring gear shroud 100 maybe coupled to an axle housing cover using a plurality of fasteners or at least one weld; however, it is understood that the ring gear shroud 100 may be coupled to an axle housing or any non-rotatable component disposed in the axle housing.

In use, the ring gear shroud 10, 100 reduces torque loss caused by agitation of the lubricant by the ring gear 70. The ring gear shroud 10, 100 reduces an amount of the lubricant disposed within an axle housing capable of being agitated by the ring gear 70 when the ring gear 70 is being driven. The ring gear shroud 10, 100 helps to reduce the oil around the ring gear thus reducing churning losses and improves overall axle efficiency. As a result, the efficiency of a drivetrain (not shown) incorporating the ring gear shroud 10, 100 is increased.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A ring gear shroud, comprising:
a unitary, integrally formed member having a first end portion, an arc-shaped middle portion, a second end portion, a first side and a second side;
said first end portion extends orthogonally from said arc-shaped middle portion and a distal end of said first end portion is oriented parallel to said arc-shaped middle, said first end portion and said second end portion each extend from said arc-shaped middle portion;
said second end portion extends orthogonally from said arc-shaped middle portion opposite said first end portion, and a distal end of said second end portion is oriented parallel to said arc-shaped middle;
said first side comprises an inner surface and an outer surface, said second side comprises an inner surface and an outer surface, said surfaces defining a first radiused opening and said surfaces defining a second radiused opening, wherein said first opening has a larger radius than said second opening;
said outer surfaces of said first side and said second side are non-symmetrical.

2. A ring gear shroud according to claim 1, wherein said distal end of said first end portion comprises an opening defined by said first side, said second side and a connecting wall extending between them.

3. A ring gear shroud according to claim 1, wherein said distal end of said second end portion comprises an opening defined by said first side, said second side and a connecting wall extending between them.

4. A ring gear shroud according to claim 1, wherein said arc-shaped middle portion extends circumferentially approximately 180 degrees.

5. A ring gear shroud according to claim 1, wherein said outer surfaces of said first side and said second side combined are defined by, in series, a first straight edge portion, a first curved portion, a second straight edge portion, a second curved portion, a third straight edge portion, a third curved portion and a fourth straight edge portion.

6. A ring gear shroud according to claim 5, wherein an end of said first straight edge portion comprises a first L-shaped lip extending perpendicularly outward from said first straight edge portion.

7. A ring gear shroud according to claim 5, where an end of said fourth straight edge portion comprises a second L-shaped lip extending perpendicularly outward from said fourth straight edge, said second L-shaped lip is larger than said first L-shaped lip.

8. A ring gear shroud according to claim 1, wherein said shroud is formed from a sheet metal having a thickness of 1.0 to 1.5 millimeters.

9. A ring gear shroud according to claim 1, wherein said shroud is formed from plastic.

10. A ring gear shroud according to claim 1, wherein said shroud is welded to an axle housing cover.

11. A ring gear shroud, comprising:
a unitary, integrally formed member having a first end portion, an arc-shaped middle portion, a second end portion, a first side and a second side wherein a ring gear is located partially within said shroud;
said first end portion and said second end portion each extend orthogonally from said arc-shaped middle portion;
said first side comprising an inner surface and an outer surface, said second side comprising an inner surface and an outer surface, said surfaces of said first side defining a first radiused opening and said surfaces of said second side defining a second radiused opening, wherein said first opening has a larger radius than said second opening;
said outer surfaces of said first side and said second side are non-symmetrical, wherein a first straight edge portion of said first side is substantially parallel to a backface of said ring gear, a first curved portion of said first side is adjacent to a heel of said ring gear, a third straight edge portion, a third curved portion and a four straight edge portion of said second side are each nonparallel and adjacent teeth of said ring gear.

12. A ring gear shroud according to claim 11, wherein said shroud is welded to an axle housing cover.

13. A ring gear shroud according to claim 11, wherein an end of said first straight edge portion comprises a first L-shaped lip extending perpendicularly outward from said first straight edge portion.

14. A ring gear shroud according to claim 11, where an end of said fourth straight edge portion comprises a second L-shaped lip extending perpendicularly outward from said fourth straight edge, said second L-shaped lip is larger than said first L-shaped lip.

15. A ring gear shroud according to claim 11, wherein a distal end of said first end portion comprises an opening defined by said first side, said second side and a connecting wall extending between them.

16. A ring gear shroud according to claim 11, wherein a distal end of said second end portion comprises an opening defined by said first side, said second side and a connecting wall extending between them.

17. A ring gear shroud according to claim 11, wherein a first L-shaped lip of said first side is radially bounded by said backface of said ring gear.

18. A ring gear shroud according to claim 11, wherein a second L-shaped lip of said second side is radially inward from a toe of said ring gear.

19. A ring gear shroud according to claim 11, wherein a gap is located between said ring gear and said first and second side inner surfaces, a width of said gap is greater on said first side then said second side.
